(19) United States
(12) Patent Application Publication
(10) Pub. No.: US 2018/0075450 A1
(43) Pub. Date: Mar. 15, 2018

(54) EFFECTING PIN CHANGE FOR PAYMENT DEVICES

(71) Applicant: VISA INTERNATIONAL SERVICE ASSOCIATION, San Francisco, CA (US)

(72) Inventor: Simon Hurry, San Francisco, CA (US)

(21) Appl. No.: 15/563,277

(22) PCT Filed: Mar. 30, 2016
(86) PCT No.: PCT/US16/25026

§ 371 Date: Sep. 29, 2017

Related U.S. Application Data
(60) Provisional application No. 62/140,768, filed on Mar. 31, 2015.

(51) Int. Cl. G06Q 20/40; G06Q 20/32; H04L 29/06

(52) U.S. Cl. CPC G06Q 20/4012; H04L 63/0846; G06Q 20/322

(57) ABSTRACT

A computer implemented method of entering a personal identification number on a payment device. The method includes establishing wireless communication between a computing device and a payment device comprising a security chip, and establishing communication between the security chip and a remote institution via the computing device over a digital communication network. The method includes receiving an entry of a personal identification number via the computing device, wirelessly transmitting the personal identification number to the payment device, and storing the personal identification number on the payment device. The method also includes transmitting, via the digital communication network, the personal identification number to the remote institution.

### CROSS-REFERENCE TO RELATED APPLICATIONS

This application claims priority to and the benefit of International Patent Application No. PCT/US2016/025026, filed Mar. 30, 2016, which claims priority to and the benefit of U.S. Provisional Application No. 62/140,768, filed Mar. 31, 2015, the entirety of which are incorporated by reference herein.

### BACKGROUND

Personal Identification Numbers or PINs are used as a security measure in electronic transactions. In order to use a payment account, a PIN may also be required before the transaction may be authorized. In the case of a physical payment device such as a card, an electronic chip may be embedded in the card. The PIN may be stored in the chip and may be secured from access unless from an authority. In order to change the PIN of such a card, physical contact with the chip may be required along with a secure communication link to an authority. As the number and location of authorized chip readers with the proper communication capabilities may be limited, changing the PIN on a chip of a card may be a challenge.

A system and methods that allows for more easily and securely updating a user PIN is needed.

### SUMMARY

In one embodiment, the disclosure describes a computer implemented method of entering a personal identification number on a payment device. The method includes establishing wireless communication between a computing device and a payment device comprising a security chip, and establishing communication between the security chip and a remote institution via the computing device over a digital communication network. The method includes receiving an entry of a personal identification number via the computing device, wirelessly transmitting the personal identification number to the payment device, and storing the personal identification number on the payment device. The method also includes transmitting, via the digital communication network, the personal identification number to the remote institution.

In another embodiment, the disclosure describes a computer implemented method of changing a personal identification number on a payment device. The method includes establishing secure wireless communication between a portable computing device and a payment device using near field communication, wherein the payment device comprises a security chip with an old personal identification number stored thereon. The method includes establishing, via a digital communication network, secure communication between the portable computing device and a remote institution. The method also includes receiving an entry of a new personal identification number via the portable computing device, and wirelessly transmitting the new personal identification number to the payment device via the near field communication. The method includes removing the old personal identification number from the security chip, storing the new personal identification number on the security chip, and transmitting, via the digital communication network, the new personal identification number to the remote institution. The method also includes storing the personal identification number at the remote institution, and closing the communication between the portable computing device and the payment device once the new personal identification number is stored on the payment device.

In yet another embodiment, the disclosure describes a computer implemented method of changing a personal identification number. The method includes establishing secure wireless communication between a computing device and a payment card using near field communication, wherein the payment card includes a security chip with an old personal identification number stored thereon. The method includes establishing, via a digital communication network, secure communication between the computing device and a remote institution. The method includes receiving an entry of a new personal identification number via the computing device, and wirelessly transmitting the new personal identification number to the payment device via the near field communication. The method also includes removing the old personal identification number from the security chip, and storing the new personal identification number on the security chip. The method also includes, transmitting, via the digital communication network, the new personal identification number to the remote institution.

### BRIEF DESCRIPTION OF THE DRAWINGS

The invention may be better understood by reference to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 is an illustration of the elements of an embodiment of a system that includes a system for effecting PIN change for payment devices as disclosed herein;

FIG. 2 is an schematic illustration of elements of an embodiment of a portable computing device;

FIG. 3 is a schematic illustration of elements of an embodiment of a server type computing device;

FIG. 4 is an illustration of a computerized method of changing a PIN on a payment device using wireless communication;

FIG. 5 is an illustration of an embodiment of a graphical user interface used by a system for effecting PIN change for a payment device.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### Specification

The present invention now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. The following detailed description is, therefore, not to be taken in a limiting sense.

Personal Identification Numbers or PINs are used as a security measure in electronic transactions. In order to use a payment account, a PIN may also be required before the transaction may be authorized. In the case of a physical payment device such as a card, an electronic chip may be embedded in the card. The PIN may be stored in the chip and may be secured from access unless from an authority. In order to change the PIN of such a card, physical contact with the chip may be required along with a secure communication link to an authority. As the number and location of authorized chip readers with the proper communication capabilities may be limited, changing the PIN on a chip of a card may be a challenge. Further, some authorities may require physical contact with the chip in order to change the PIN on the card to ensure the security of the PIN on the chip.

As described herein, the PIN stored on a chip on a card may be accessed through near field communication (NFC) by a computing device such as a smart phone with NFC capability. The NFC may be of a variety of physical forms or formats such as WiFi, 802.11, Bluetooth, BLE, infrared, etc. The computing device may be in communication with an authority such as the smart phone communicating in a secure manner with a card issuer over a secure communication channel. In response to trust being established between the authority computing device and the chip through NFC on the computing device, the PIN may be changed on the card and at the authority. As a result, it may be much more convenient for a card holder to change the PIN on a card which may make PIN use easier to accept and become more common.

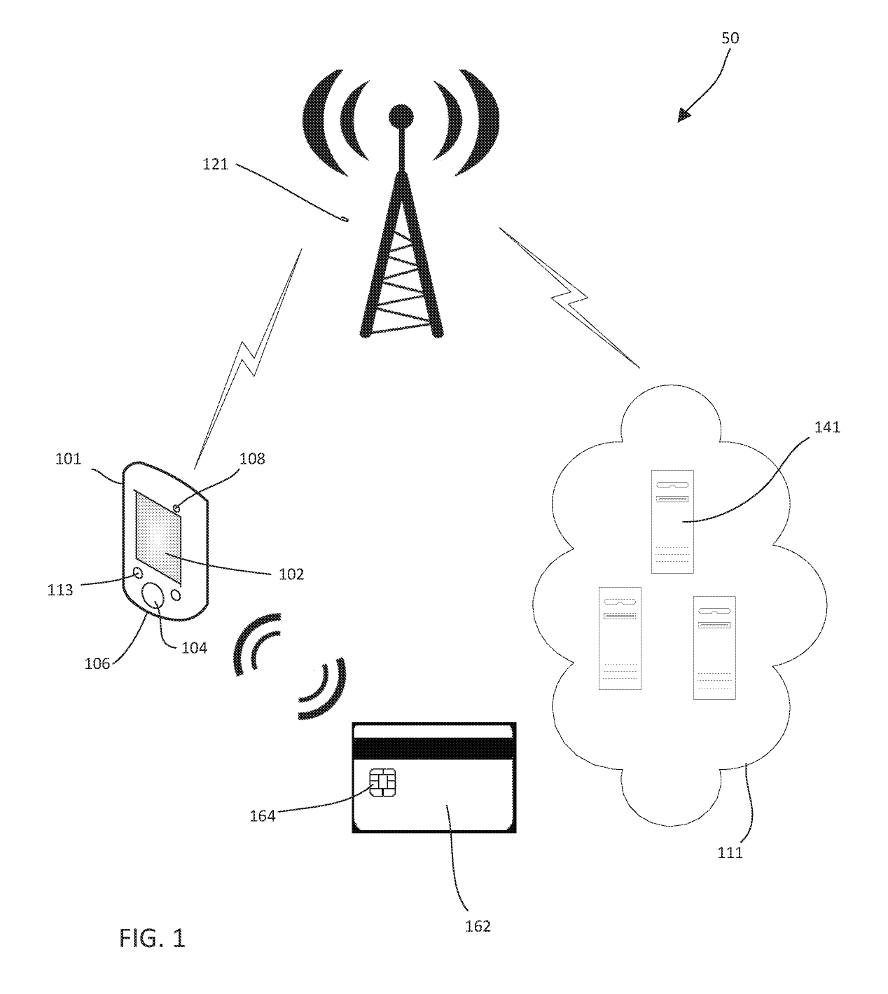

FIG. 1 is a high level illustration of some of the elements a sample computing system 50 that may be physically configured to implement the PIN change method and system shown and described herein. The computing system 50 may include a dedicated computing device 141, a dedicated portable computing device 101, an application on the computing device 141, an application on the portable computing device 101 or a combination of all of these. FIG. 1 shows high level illustration of an embodiment of a portable computing device 101 communicating with a remote computing device 141, but the application may be stored and accessed in a variety of ways. FIG. 1 may be a high level illustration of a portable computing device 101 communicating with a remote computing device 141 but the application may be stored and accessed in a variety of ways. The portable computing device 101 may be any of a variety of computing devices, such as a cellular telephone, tablet computer, laptop computer, desktop computer, etc. In addition, the application may be obtained in a variety of ways such as from an app store, from a web site, from a store WiFi system, etc. There may be various versions of the application to take advantage of the benefits of different computing devices, different languages and different API platforms.

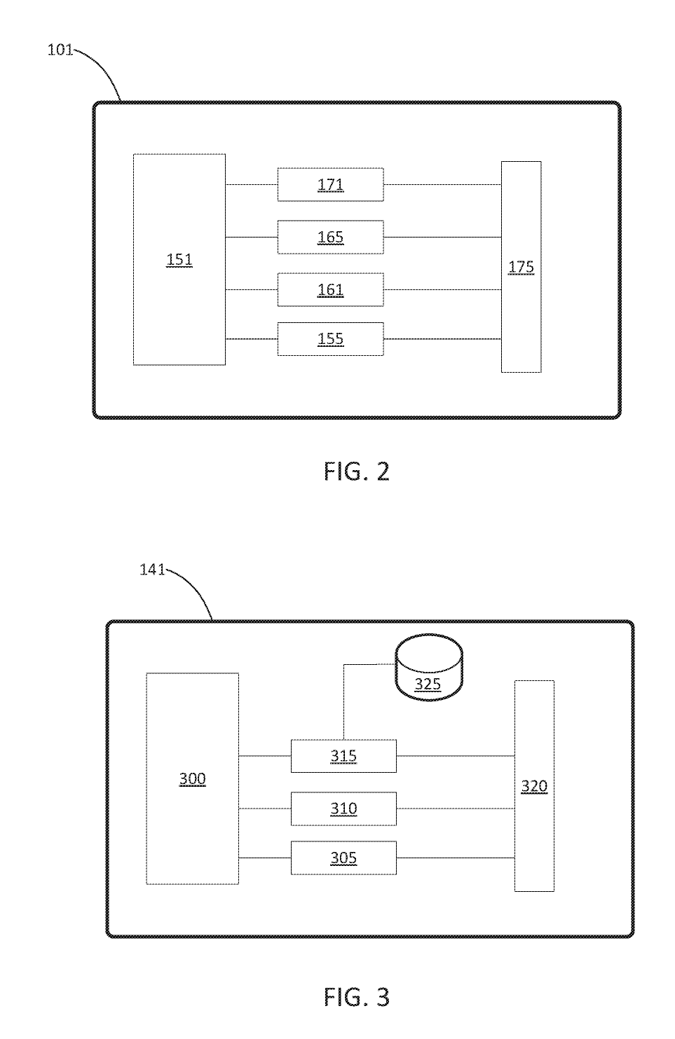

In one embodiment, a portable computing device 101 may be a device that operates using a portable power source 155, as shown in FIG. 2, such as a battery. The portable computing device 101 may also have a display 102 which may or may not be a touch sensitive display. More specifically, the display 102 may have a capacitance sensor, for example, that may be used to provide input data to the portable computing device 101. In other embodiments, an input pad 104 such as arrows, scroll wheels, keyboards, etc., may be used to provide inputs to the portable computing device 101. In addition, the portable computing device 101 may have a microphone 106 which may accept and store verbal data, a camera 108 to accept images and a speaker 113 to communicate sounds.

The portable computing device 101 may be able to communicate with a computing device 141 or a plurality of computing devices 141 that make up a cloud of computing devices 111. The portable computing device 101 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 141 or may be through a communication network 121 such as cellular service, through the Internet, through a private network, through Bluetooth, etc.

The embodiment of system 50 in FIG. 1 also includes a payment device 162. In some embodiments, the payments device 162 includes an electronic chip 164 that can have security data stored thereon. The electronic chip 164 can wirelessly communicate with the portable computing device 101 through any of a variety of wireless communicating protocol, such as near field communication (NFC) or Bluetooth. In some embodiments, the payment device 162 can be a credit card, but any other suitable payment device is also contemplated. Further, in some embodiments, the computer chip 164 may be used to store data and assist in verifying transactions for which the payment device 162 is used to complete. The payment device 162 and chip 164 also may have the ability to send and receive wireless communications in a variety of formats. The format of communication may be many and varied. As just some examples and not limitations, the communication may occur using Bluetooth, BLE, 802.11 type communications such as WiFi, ultrahigh frequency type communications such as 60 mHz type communications, beacon type communications, or a combination thereof.

The payment device 162 may take many forms and may have a variety of uses. In a most easily understandable example, a credit card may be a payment device. At a high level, the payment device 162 may have a computer and/or electronic chip 164 which is of a size that it may fit in a credit card. The payment device 162 also may have physical contacts in known locations which may be used to communicate with an additional computing device through the contacts. The physical contacts may be accessible from the payment device 162 and the contacts may be in communication with the electronic chip 164. It also may have a power source which may be a battery or other portable power source.

In some embodiments, the electronic and/or computer chip 164 is a processor which may be in communication with a memory and an input output circuit. The memory may secure and may only be accessed by an authority. The memory may store the PIN which may be in an encrypted format. The memory also may store algorithms which may be executed by the processor for a variety of purposes such as verifying an authority.

The payment device 162 may take on many forms. As previously mentioned, a credit card is an example. In addition, other forms are possible. For example, a chip and related processor may be of a size that they may be stored in a variety of devices such as a necklace, a bracelet, a ring or in other wearable forms or items commonly or easily carried. In some embodiments, the electronic chip 164 may be part of another device such as a watch, a smart phone, a fitness device, etc. As the chip 164 has wireless capability, it may not be necessary to have the contacts that are in communication with the chip be physically accessible or at all.

In yet another embodiment, the payment device 162 may be an application that operates on a portable computing device such as a smart phone. In such an embodiment, the chip 164 may be part of a secure element of the application that can only be accessed by those with sufficient authority.

In some embodiments, the PIN may be a second form of authentication. For this reason, the PIN may need to be kept secure. The security may be effectuated in a variety of ways such as through encryption of through an algorithm. In some embodiments, the PIN may be kept secure according an a standard such as the EMVCO standard.

FIG. 2 is a simplified illustration of the physical elements that make up a an embodiment of a portable computing device 101 and FIG. 3 is a simplified illustration of the physical elements that make up a server type computing device 141. Referring to FIG. 2, a sample portable computing device 101 is illustrated that is physically configured to be part of the system 50 shown in FIG. 1. The portable computing device 101 may have a portable power supply 155 such as a battery which may be rechargeable. It may also have a sound and video module 161 which assists in displaying video and sound and may turn off when not in use to conserve power and battery life. The portable computing device 101 may also have volatile memory 165 and non-volatile memory 171. The portable computing device 101 may have GPS capabilities that may be a separate circuit or may be part of the processor 151. There also may be an input/output bus 175 that shuttles data to and from the various user input/output devices such as the microphone 106, the camera 108, a display 102, or other input/output devices. The portable computing device 101 also may control communicating with the networks, such as communication network 121 in FIG. 1, either through wireless or wired devices. Of course, this is just one embodiment of the portable computing device 101 and the number and types of portable computing devices 101 is limited only by the imagination.

The physical elements that make up an embodiment of the remote computing device 141, such as the remote institution, are further illustrated in FIG. 3. In some embodiments, the remote computing device 141 is a server or, more specifically, a guest tracking server specially configured to run the guest checkout decision engine as described herein. At a high level, the computing device 141 may include a digital storage such as a magnetic disk, an optical disk, flash storage, non-volatile storage, etc. Structured data may be stored in the digital storage such as in a database. More specifically, the computing device 141 may have a processor 300 that is physically configured according to computer executable instructions. In some embodiments, the processor 300 can be specially designed or configured to optimize communication between a portable computing device, such as portable computing device 101, and the computing device 141 relating to the guest checkout decision engine described herein. The computing device 141 may also have a sound and video module 305 which assists in displaying video and sound and may turn off when not in use to conserve power and battery life. The computing device 141 may also have volatile memory 310 and non-volatile memory 315.

A database 325 for digitally storing structured data may be stored in the memory 310 or 315 or may be separate. The database 325 may also be part of a cloud of computing device 141, such as cloud 111 in FIG. 1, and may be stored in a distributed manner across a plurality of computing devices 141. There also may be an input/output bus 320 that shuttles data to and from the various user input devices such as a microphone, a camera, a display monitor or screen, etc. The input/output bus 320 also may control communicating with the networks, such as communication network 121, either through wireless or wired devices. In some embodiments, the application running the guest checkout decision engine may be located on the portable computing device 101. However, in other embodiments, the application may be located on remote computing device (guest tracking server) 141, or both the portable computing device and the remote computing device 141. Of course, this is just one embodiment of the remote computing device 141 and additional types of portable computing devices 141 are contemplated herein.

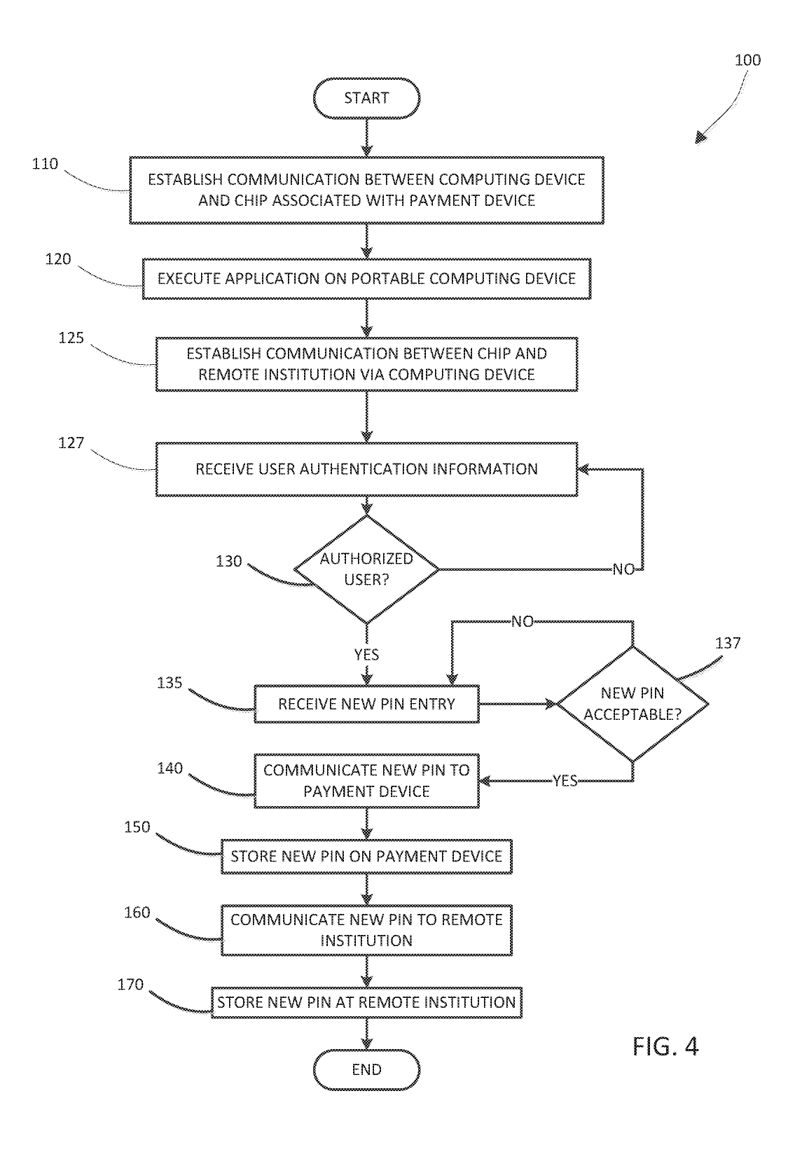

FIG. 4 a flow chart depicting an embodiment of a method 100 of changing a PIN on a payment device using wireless communication. At block 110, secure wireless communication may be established between a computing device with near field communication (NFC) capabilities, such as the portable computing device 101 in FIG. 1 and a payment device, such as the payment device 162 in FIG. 1, comprising a security chip 164 with near field communication capability.

At block 120, an application may be executed on the portable computing device 101. At block 125, the application can establish secure communication between the security chip 164 and computing devices 141 associated with a remote institution. As mentioned previously, the communication may take on a variety of forms and formats. The format may be known in advance and the known format may be used. In another embodiment, the application may attempt a variety of formats until a format is located which is capable of communicating with the security chip. In yet another embodiment, the communication may use a variety of communication formats at the same time, such as using one form to being the communication process and another form to complete the PIN changing process. The remote institution with which the computing devices or server 141 is associated could be a payment service, such as a credit card company or bank, or another such institution.

At block 127, in some embodiments, the application can request and receive user authentication information. In such embodiments, the user may have to be authenticated to the application to assure that only authorized users of the payment device 162 can access the application and change a PIN on the payment device. Thus, a user may have to use a username, password, or other authentication system to ensure only a desired user may be allowed to change a PIN for the payment device 162. Further, biometric authentication or other manners of authenticating a user may be possible and are contemplated. In response to a user being authenticated by the application, the user may be permitted to enter a new PIN that is received by the application. In some embodiments, the portable computing device 101 used to access the application can include built-in or stored authentication procedures through which the application can verify the user's identity. At block 130, the application confirms whether the user is an authorized user of the application. If the user is not authorized or the authentication information entered by the user does not match the stored authentication information checked by the application, the application can, in some embodiments, request the information again at block 127.

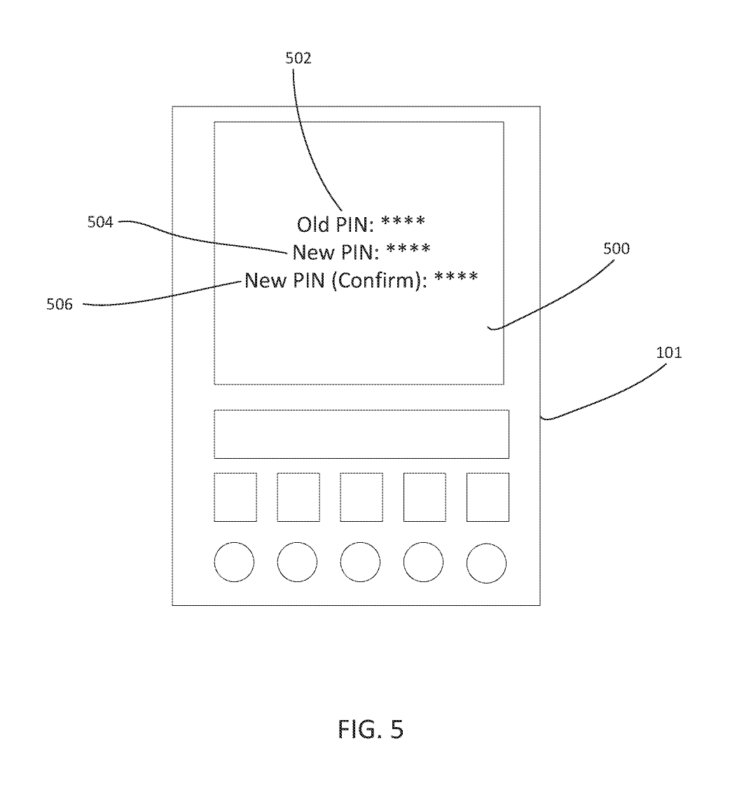

If the user authentication information received by the application is approved, the application can receive a new PIN entry at block 135. To receive the new PIN and manage the PIN changing process, in some embodiments the application may have a unique graphical user interface 500 which may be illustrated in FIG. 5. The graphical user interface 500 may assist the user through the process, may track progress, may provide help options and may ensure the process is as intuitive as possible while maintaining the desired security. As shown in the embodiment of the graphical user interface 500 in FIG. 5 running the application on a portable computing device 101, the application may request entry of an old PIN at 502 as a security measure. The application can also request a new PIN at 504, and request confirmation of the new PIN at 506 to ensure that the user has entered the PIN correctly. It should be understood many different suitable interfaces for effecting the PIN change are contemplated herein, and the interface in FIG. 5 is just one example. Further, in some embodiments, the application can confirm whether the new PIN is acceptable at block 137 it is contemplated that the application can insist that a new PIN be distinguishable from the old PIN, or that the new PIN is not the same as previously used PINs. In some embodiments, this check against previous PINs can be performed at the institution server 141 instead of on the portable computing device. It is also contemplated that the application can be run either on the portable computing device 101 or on the institution server 141 and accessed through an internet browser or other application via the portable computing device.

Referring again to FIG. 4, at block 140, the new PIN may be communicated to the payment device 162 using, for example, near field communication once the PIN has been entered and approved. As mentioned previously, the communication may follow a variety of forms and formats which may be used alone or in combination. For example and not limitation, the communication may use Bluetooth, BLE, WiFi, Infrared, Ultra high frequency, beacon based communication, etc. Logically, significant security may be used to ensure the communication between the computing device 101 and the payment device 162 is secure and has trust between the parties such as encryption using a token exchange, using biometric authentication, using tokens, etc.

In addition, NFC communication to the payment device 162 may occur in a standard manner as explained in current standards such as EMVCO standards. However, many current standards do not allow the PIN to be changed without physical contact with the payment device 162. Thus, the current standards may have to be modified to allow the wireless changing of PINs. Further, the change in standards may have to be communicated to the payment devices 162 such that the wireless modification may be accepted and effectuated.

At block 150, in response to sufficient trust being established between the application of the payment device 101 (or institution server 141), the new PIN may be stored on the payment device. As mentioned previously, the PIN may be stored in the memory of the payment device in a secure manner. The memory may be virtually any appropriate memory such as a flash memory device. In some embodiments, the new PIN is stored on the electronic security chip 164 included in the payment device 162 for future reference during transactions.

At block 160, the new PIN may be communicated to the remote institution and/or to the computer server 141 at the remote institution. The communication may be trusted communication and may occur through the portable computing device 101 which may be in communication through a communication network, such as the digital communication network 121 in FIG. 1. In one embodiment, the portable computing device 101 may use WiFi or cellular communication to contact an outside network which may be used to securely contact the remote institution. In yet another embodiment, the portable computing device 101 may contact a payment network such as the Visa payment network and the communication may occur over the payment network.

In some embodiments, verification from the remote institution 141 that the PIN has been accepted or meets the minimum standards may be required. For example, if the PIN has to be at least six digits and only four digits are received, the PIN may be rejected by the remote institution and the user may be asked to enter a compliant new PIN. Similarly, the payment device 162 may have to indicate that the PIN was successfully stored. If either the payment device 162 or remote institution 141 indicates that the new PIN was not successfully stored, end error may be displayed and the old PIN may continue to be in effect until a time when an acceptable new PIN is entered.

At block 170, the new PIN may be stored at the remote institution 141. In response to the new PIN being successfully being stored at the remote institution 141 and on the payment device 162, the communication between the payment device and the portable computing device 101 may be closed and the communication to the remote institution 141 and the portable computing device may be closed.

The system and method for PIN change described and shown herein may have several uses and address several technical problems. In instances where access to a physical terminal is difficult, a PIN may be changed using a portable computing device 101 with wireless communication capabilities at virtually any location that has sufficient network coverage. PIN changes which would not have occurred in the past will now occur. Providing a user with easier PIN changes can enhance the security of the payment method used because, in the event that a PIN is discovered by a third party, the PIN can be changed before the third party can use the old PIN for an otherwise unauthorized transaction using the payment method associated with the PIN. With greater security, users will be more confident in using the payment device or associated payment methods more frequently, resulting in additional sales.

Further, as a result of the system, merchants may be able to sell items in locations that were inaccessible previously. As a result, users may make more sales. The system is more than just speeding a process but uses a computing system to achieve a new and better outcome. The system and methods disclosed herein provide users with greater access to payment method security that were not previously available. From a technical standpoint, the system and method disclosed herein addresses several problems that only occur in digital, computer based payment systems. While paying with a payment device having electronic security chips to confirm and authenticate authorized users may create efficiencies, the inability to easily and securely change a user PIN reduces the efficiencies of using the payment systems and methods as users may be hesitant to frequent use of a payment device for which the PIN may be compromised and not readily changed. The disclosed methods and system solve this problem by providing secure, convenient methods for changing a user PIN for a payment device used in an electronic payment system.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated. The attached Appendix may provide more detail regarding the operation of a payment system.

The present disclosure provides a solution to the long-felt need described above. In particular, the systems and methods described herein may be configured for improving payment systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer implemented method of entering a personal identification number on a payment device, the method comprising:
establishing wireless communication between a computing device and a payment device comprising a security chip;
establishing communication between the security chip and a remote institution via the computing device over a digital communication network;
receiving an entry of a personal identification number via the computing device;
wirelessly transmitting the personal identification number to the payment device;
storing the personal identification number on the payment device; and
transmitting, via the digital communication network, the personal identification number to the remote institution.

2. The method of claim 1, wherein the personal identification number is a new personal identification number that replaces an old personal identification number stored on the payment device.

3. The method of claim 1, further comprising storing the personal identification number at the remote institution.

4. The method of claim 1, wherein the security chip includes near field communication capabilities, and wherein the wireless communication between the computing device and the payment device including the security chip is via near field communication.

5. The method of claim 1, wherein the near field communication is at least one of Bluetooth low energy, WiFi, Infrared, Ultra high frequency, or Beacons.

6. The method of claim 1, wherein the computing device is a portable computing device.

7. The method of claim 1, wherein the payment device is a payment card.

8. The method of claim 1, wherein the payment device is an application operating on another computing device with a secure element.

9. The method of claim 1, wherein the communication between the computing device and the payment device and the communication between the computing device and the remote institution are both secure communication.

10. A computer implemented method of changing a personal identification number on a payment device, the method comprising:
establishing secure wireless communication between a portable computing device and a payment device using near field communication, wherein the payment device comprises a security chip with an old personal identification number stored thereon;
establishing, via a digital communication network, secure communication between the portable computing device and a remote institution;
receiving an entry of a new personal identification number via the portable computing device;
wirelessly transmitting the new personal identification number to the payment device via the near field communication;
removing the old personal identification number from the security chip;
storing the new personal identification number on the security chip;
transmitting, via the digital communication network, the new personal identification number to the remote institution;
storing the personal identification number at the remote institution; and
closing the communication between the portable computing device and the payment device once the new personal identification number is stored on the payment device.

11. The method of claim 10, wherein the near field communication is at least one of Bluetooth low energy, WiFi, Infrared, Ultra high frequency, or Beacons.

12. The method of claim 10, wherein the payment device is a payment card.

13. A computer implemented method of changing a personal identification number, the method comprising:
establishing secure wireless communication between a computing device and a payment card using near field communication, wherein the payment card includes a security chip with an old personal identification number stored thereon;
establishing, via a digital communication network, secure communication between the computing device and a remote institution;
receiving an entry of a new personal identification number via the computing device;
wirelessly transmitting the new personal identification number to the payment device via the near field communication;
removing the old personal identification number from the security chip;
storing the new personal identification number on the security chip; and
transmitting, via the digital communication network, the new personal identification number to the remote institution.

14. The method of claim 13, wherein the remote institution is an issuer of the payment card.

15. The method of claim 13, further comprising receiving user authentication information via the computing device.
